(19) United States
(12) Patent Application Publication
(10) Pub. No.: US 2004/0212478 A1
(43) Pub. Date: Oct. 28, 2004

(54) Remote control activator with voice data memory and associated method

(76) Inventors: John Kutsuzawa, Wyckoff, NJ (US); Kasey Kutsuzawa, Wyckoff, NJ (US)

Correspondence Address: BLACKWELL SANDERS PEPER MARTIN LLP, 720 OLIVE STREET, SUITE 2400, ST. LOUIS, MO, 63101, US

(21) Appl. No.: 10/423,502

(22) Filed: Apr. 25, 2003

(51) Int. Cl. H04Q 1/00; G05B 19/00

(52) U.S. Cl. 340/5.6; 340/5.52

(57) ABSTRACT

A remote control activator for use with vehicles is provided. The remote control activator includes an information storage device, which permits a user to record a message for later dissemination.

### BACKGROUND OF INVENTION

The present invention relates to a remote control activator for remote controlled vehicle devices such as door and trunk locks and which has integrated voice information input and memory devices.

Vehicles, such as cars and trucks are commonly equipped with a remote control transmitter, usually attached to a vehicle key. The remote control activator typically will have several such as push activators or buttons which when activated will allow certain functions to be performed at the vehicle. Such functions include unlocking and locking a door, unlocking a trunk and/or sounding an alarm. Such remote control activators are well known in the art and permit a user to operate certain vehicle functions without the necessity of using a key or being within physical reach of the vehicle. Such remote control activators provide both convenience and security.

Remote control activators are effective in providing for the user's convenience. While providing convenience, however, the assistance provided is limited to only remote control of various vehicle functions. In today's society, life is becoming very complex and people are in constant need for additional assistance and to have that assistance provided in a simple and effective manner that is readily available. As people drive, many think about work and household matters and oftentimes lose those thoughts because of their inability to write notes. Also, when departing from a vehicle, information may need to be retained, for example, to help locate where one parks their vehicle. Typically, people do not carry a pen and paper to record such information or if they do, they are inconvenient to use. Also, while away from the vehicle, information may need to be preserved so that if forgotten, may be readily recalled.

While portable information storage devices are well known, for example portable tape recorders, they are typically not carried by people, may be easily forgotten or are too bulky to conveniently carry. However, when traveling in a vehicle, one usually has their keys and the remote control activator for the vehicle. Therefore, it would be desirable to provide more functionality and convenience to a driver or passenger of a vehicle, which provides a higher level of confidence that one will have with them a means to record voice information with a remote control activator, which remote control activator can also be used to enhance the security for the carrier of the remote control and for the vehicle.

### SUMMARY OF INVENTION

The present invention involves the provision of a remote control activator for operating various functions of a vehicle, for example the door lock or trunk lock with an information storage unit combined in a housing for convenience. The device may include the typical remote control function activators, for example a door lock button, a trunk lock button and an alarm button. The remote control activator also includes an information storage device, which can be used to store information in the form of voice data and allow the selective output of that voice data in a convenient format as desired. The device may also provide enhanced security by having a voice recognition function that would prevent the transmitter from being used for operating a vehicle function without first receiving a voice command that identifies the user as an approved user. The information storage device is provided with activators for allowing the selective input and the selective output of the desired information. The information storage device includes a memory device, which preferably does not require a significant consumption of energy to maintain the recorded information stored. This remote control activator may be sold with new vehicles or by itself as an after market sale product.

The above are merely illustrative aspects of the present invention and should not be deemed an all-inclusive listing of the innumerable aspects associated with the present invention. These and other aspects will become apparent to those skilled in the art, in view of the following disclosure and accompanying drawings.

### BRIEF DESCRIPTION OF DRAWINGS

For a better understanding of the present invention, reference may be made to the accompanying drawings in which:

FIG. 1 is a schematic diagram showing the components of the remote control activator of the present invention; and

FIG. 2 is a plan view of the remote control activator of the present invention.

### Throughout the figures listed above, like numerals designate identical or similar parts.

### DETAILED DESCRIPTION

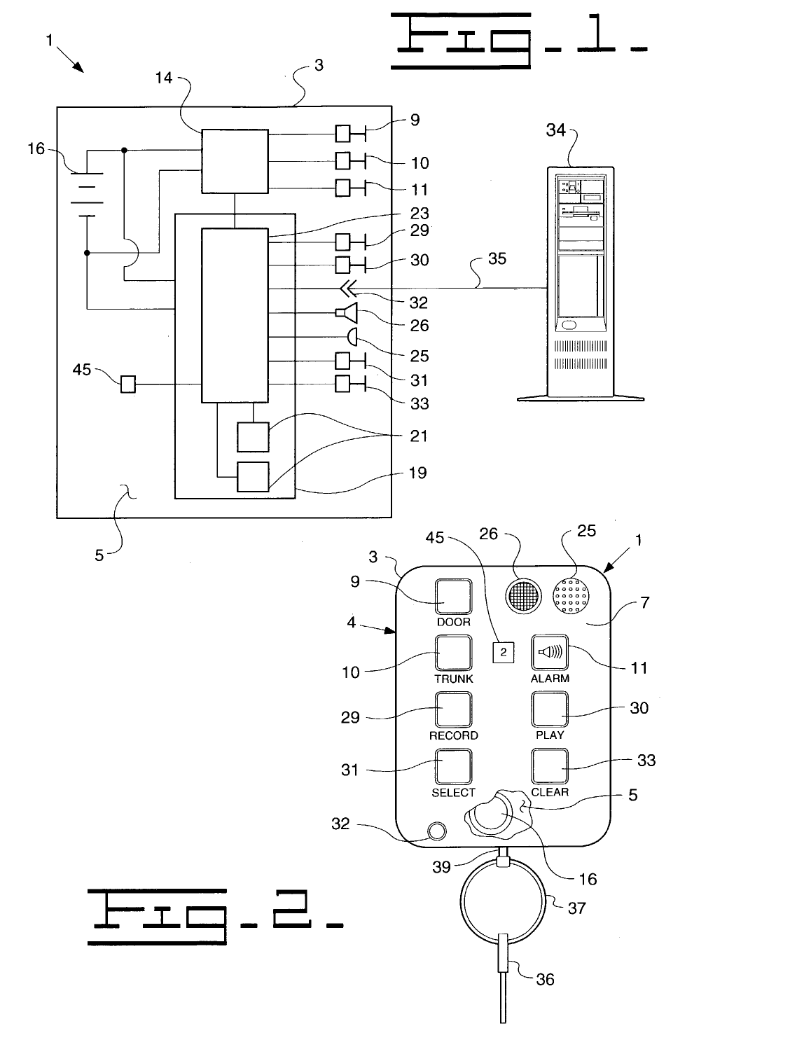

A device that can be used for both the remote control of wide a variety of functions involving vehicles (e.g., car, truck, and so forth) and the selective recording and dissemination of certain information is generally indicated by numeral 1. The remote control activator 1 includes a housing 3 that has both an exterior 4 and an interior 5. The exterior 4 has exposed on one or more of the surfaces thereof, certain control devices for selective activation by a user. The control devices are described in detail below. Generally, the control devices are mounted for access on one face 7 of the remote control activator 1. The control devices may include activators 9, 10 and 11 for vehicle functions. Any suitable number of activators may be provided and three are shown. Less than three or more than three may be provided for other embodiments of this invention. The activator 9 is used for locking and unlocking the passenger doors which may be accomplished by sequentially pressing the activator 9 with a finger, with one activation unlocking the door and the next activation locking the door. The typical controller uses two activators, one for locking, one for unlocking. Only one activator is shown for convenience. A timer may be provided for use with the activator 9 for selection of lock or unlock, e.g., a long activation (1.5 second activation) for locking and a short activation (less than 1 second) for unlocking. The activator 10 operates like the activator 9 but remotely controls the unlocking of the trunk or rear door or gate, herein referred to collectively as a “trunk” for convenience. Typically, locking of the trunk is not required so in this case, the activator 10 will unlock the trunk on each activation thereof. The activator 11 may be used to activate an alarm mounted in the vehicle. The alarm may be activated by actuation of the activator 11 and may be turned off with the next actuation of activator 11. Preferably, the activators 9, 10, 11 are exposed on the face 7 for operation with manually operated push buttons. As best-illustrated in FIG. 1, the remote control activator 1 includes a transmitter 14 mounted in the interior 5 of the remote control activator 1. The transmitter 14 is powered by a power supply, e.g., battery, 16 and is operably connected to the transmitter 14. The activators 9, 10, 11, are also operably connected to the transmitter 14. The transmitter 14 may include a processor, e.g., microprocessor, 23 to assist in its operation but may simply operate by the opening and closing of circuits by the activators 9, 10, and 11.

The remote control activator 1 includes an information storage device 19 that is preferably mounted in the interior 5. The information storage device 19 is best seen schematically in FIG. 1. The information storage device 19 includes one or more memory devices 21 (two being illustrated) which may be in the form of a RAM chip or a flash memory and is preferably of a type that does not require continuous energy or very little energy to maintain storage of input information. The information storage device 19 can include a processor 23 or controller that will convert analog input information to a digital form for storage in a memory device 21. The memory devices 21 may also be an analog device. For example, this can include a cassette tape recorder. The processor 23 may also be constructed and programmed for voice recognition. Input voice information may be recorded and analyzed for recognition as is well known in the art. The processor 23 can then be connected to the transmitter 14, which will prevent its operation unless the processor 23 recognizes the voice trying to activate the remote control activator 1. A voice recognition capability can be used to prevent unauthorized access to the vehicle or the activation of the alarm, which will prevent sound from being emitted from a sound output device (not shown), for example a speaker, buzzer, or the horn of the vehicle, through the remote control activator 1. The storage device 19 has an information input device 25, an information output device 26 and at least one activator. The activator, in a preferred embodiment includes an input activator 29, which is shown as a manually operated button that initiates the record function. There is also included an output activator 30 which is shown in the form of a manually operated button for initiating the playback of the information stored in a memory device 21. The input device 25 may be in the form of a microphone and the output device 26 may be in the form of a speaker or an electronic display, e.g., liquid crystal diode (LCD) screen, which would show the information in letter format. There may also be provided a connector, e.g., jack, 32 usable for connecting at least one memory device 21 and the processor 23 to a supplemental device 34, for example a computer or another information recorder for transferring the information from the at least one memory device 21 to the supplemental device 34.

Two memory devices 21 are shown but it is to be understood that any suitable number of memory devices 21 may be provided allowing a separate block of information to be recorded thereon allowing multiple blocks of information to be stored simultaneously for selective output, either through the connector 32 or the output device 26. A preferred number of memory devices 21 would be five (5). Multiple memory devices may be built into one component, e.g., integrated circuit. It is also to be understood that one or more of the memory devices 21 may be removed from the remote control activator 1 and inserted directly into a supplemental device 34 for transmission of the information stored therein to the supplemental device 34. Preferably, there is another input activator 31 that may be in the form of a pushbutton that allows the user to select the memory device 21 that will either playback or record. The number identifying the selected memory can be displayed via an electronic display 45, e.g., liquid crystal diode (LCD) display. The display 45 can also indicate which of the memories is full and which is empty to help prevent overwrite with the words “FULL” and “EMPTY” displayed. A bar graph could also be used to indicate degree of space taken in a memory. Another input activator 33, which is preferably in the form of a pushbutton, allows the user to clear a selected memory device 21. An electronic display 45 can also include light-emitting diodes, cathode ray tube, plasma screen and other types of electronic displays. Although the activators 9, 10, 11, 29, 30, 31 and 33 are preferably located on the exterior 7 of the remote control activator 1, the activators 9, 10, 11, 29, 30, 31 and 33 can be recessed or concealed if so desired.

The remote control activator 1 is shown as being connected to a vehicle key 36 by a key ring 37. There may also be provided a retractable lanyard 39 which would allow the key to be inserted into the ignition or the like of a vehicle and the remote control activator 1 be movable away from the ignition or the like for use by a user and then by retraction of the lanyard, the remote control activator 1 may be held adjacent to the key 36 as is the normal mode of use. In additional, quick disconnect may be used in place of the lanyard 39 or used in combination therewith.

In use, a user (not shown) can utilize the remote control activator 1 to lock and unlock the door by sequentially pressing the activator 9. Other modes of operation may be used for the above-described alternate embodiments such as a first activator for locking the car door and a separate second activator for unlocking the car door. The user may also unlock the trunk 10 by activating the activator 10. The alarm may be activated and deactivated by sequentially pressing the activator 11. The use of the remote control activator 1 to operate the door, trunk and alarm, for example, may be precluded if the remote control activator 1 includes the above described security system of requiring a recognized voice to be received by the remote control activator 1. If the security system is included in the remote control activator 1 then prior to activating any of the activators 9, 10, 11, an input voice signal from the user will be required. To use the information storage device 19, for example, to make a verbal note as to the location of the car or vehicle when it is parked, the user will activate the input activator 29 which will allow the user to input a message for storage in a memory device 21. The use of a specific memory device 21 is possible though activator 31, which will display the desired memory device 21 on the electronic display 45. Multiple messages may be recorded in at least one memory device 21 either by input into a single memory device 21 or sequentially into one of a plurality of memory devices 21.

The stored information may be selectively outputted through the output device 26 by activating the activator 30 or erased through the use of activator 33. In a preferred mode of operation, the output device is a speaker and allows the user to playback the input voice information as voice information. The remote control activator 1 may also be connected to the supplemental device 34 through the connector 32 allowing the stored information to be input into the supplemental device 34, for example, a transcriber or computer for subsequent use. After the stored information has been exposed or disseminated, the memory device 21 may have the information stored therein deleted, for example, by contacting activator 33 or by simultaneously activating both activators 29 and 30 which would send a delete message to the storage device 19. This function could be used to either delete the stored information or permit the storage device 19 to overwrite the information stored in a memory device 21.

Thus, there has been shown and described a novel remote control activator 1 with voice data memory, which remote control activator 1 fulfills all of the objects and advantages sought therefor. This remote control activator 1 may be sold either with the purchase of a new vehicle or in the after market as a stand-alone accessory for a vehicle. Many changes, modifications, variations and other uses and applications of the present unit will, however, become apparent to those skilled in the art after considering this specification and the accompanying drawings. All such changes, modifications, variations, and other uses and applications which do not depart from the spirit and scope of the present invention are deemed to be covered by the invention which is limited only by the claims which follow.

1. A remote control activator for use with a vehicle, the activator includes:
a housing with an exterior and an interior;
at least one vehicle component activator element attached to the housing;
a transmitter operably connected to the activator element and operable to selectively transmit a signal to a vehicle to operate at least one device associated with a vehicle;
an information storage device carried by the housing and operable to record and store voice information, said storage device includes a controller operable to selectively place the storage device in an information receiving mode and an information output mode;
an information input device operably connected to the storage device operable to accept information for transfer to the storage device; and
an information output device operably connected to the storage device operable to output at least a portion of information stored in the storage device.

2. The remote control activator as set forth in claim 1, wherein the storage device includes at least one memory device.

3. The remote control activator as set forth in claim 2, wherein the at least one vehicle component activator includes at least one manually operable button exposed on the exterior of the housing.

4. The remote control activator as set forth in claim 2, wherein the at least one vehicle component activator at least two manually operable buttons exposed on the exterior of the housing, one button being operable to activate a record mode of the storage device and another button being operable to activate an output mode of the storage device to output at least a portion of information stored in the memory device.

5. The remote control activator as set forth in claim 1, wherein the information input device includes a microphone.

6. The remote control activator as set forth in claim 1, wherein the information output device includes a speaker.

7. The remote control activator as set forth in claim 1, wherein the information output device includes an electronic display.

8. The remote control activator as set forth in claim 5, wherein the controller includes a voice activated component operable to activate the information storage device by voice command for recording of information.

9. The remote control activator as set forth in claim 2, wherein the information storage device is operable for storing information in digital format.

10. The remote control activator as set forth in claim 1, wherein the information input device includes a manually operated pushbutton for activation thereof

11. The remote control activator as set forth in claim 1, wherein the information output device includes a manually operated pushbutton for activation thereof;

12. The remote control activator as set forth in claim 5, wherein the information storage device includes a processor operably connected to the transmitter and operable to recognize the sender of a voice command to the storage device and prevent the sending of a signal from the transmitter without recognition of the voice of the sender.

13. The remote control activator as set forth in claim 2, wherein the at least one memory device includes a plurality of memory devices.

14. The remote control activator as set forth in claim 13, further including an input device to select a particular memory device from the plurality of memory devices.

15. The remote control activator as set forth in claim 13, further including an electronic display to indicate a particular memory device of the plurality of memory devices that has been selected.

16. A remote control activator for use with a vehicle, the remote control activator comprising:
a housing with an exterior and an interior;
a power supply capable of being carried by the housing;
a plurality of vehicle component activator elements exposed for operation on the exterior of the housing;
a transmitter operably connected to the activator elements and operably to selectively transmit a signal to a vehicle to selectively operate one or more of a plurality of devices associated with a vehicle;
an information storage device carried by the housing and operable to record and store voice information, the information storage device includes at least one memory device and a controller operable to selectively place the information storage device in an information receiving mode, an information output mode and an information delete or overwrite mode;
an information input device operably connected to the information storage device operable to accept information for transfer to the storage device; and
an information output device operably connected to the storage device and operable to allow at least a portion of information stored in the storage device to be output from the storage device.

17. The remote control activator as set forth in claim 16, wherein the output device includes a speaker and the input device includes a microphone.

18. A method of operating a remote control activator and information storage device having an information storage device comprising:
selecting one of a plurality of activator elements for the remote control activator, the plurality of activator elements each being operably connected to at least one of a respective device including a transmitter device and a voice information storage device;
selectively activating at least one of the plurality of activators to effect a remotely controlled operation on a vehicle;
selectively activating at least one of the plurality of activators to effect operation of the information storage device;
inputting voice information into the information storage device for storage; and
activating at least one of the plurality of activators to effect output of at least a portion of the stored voice information.

19. The method as set forth in claim 18, wherein the remotely controlled function of the vehicle is selected from the group consisting of at least one door locking, at least one door unlocking, at least one rear door or trunk unlocking and at least one alarm activation.

20. A method as set forth in claim 18, wherein the activating of the voice information storage device for input of voice information for storage is accomplished at least partially by depressing a push button.

21. The method as set forth in 18, wherein the activating of the voice information storage device for output of stored voice information is at least partially accomplished by depressing a push button.
